(19) United States
(12) Patent Application Publication
(10) Pub. No.: US 2022/0267488 A1
(43) Pub. Date: Aug. 25, 2022

(54) POLYETHYLENE FOR INJECTION STRETCH BLOW MOLDING AND METHODS THEREOF

(71) Applicants: Braskem S.A., Camaçari (BR); SERVIÇO NACIONAL DE APRENDIZAGEM INDUSTRIAL DEPARTAMENTO REGIONAL DO RIO GRANDE DO SUL., Porto Alegre (BR)

(72) Inventors: Leonardo Souza Bento, São Paulo (BR); Augusto Cesar Esteves, São Paulo (BR); André Luís dos Santos da Silva, São Paulo (BR); Marcelo Farah, São Paulo (BR)

(73) Assignees: Braskem S.A., Camaçari (BR); SERVIÇO NACIONAL DE APRENDIZAGEM INDUSTRIAL DEPARTAMENTO REGIONAL DO RIO GRANDE DO SUL., Porto Alegre (BR)

(21) Appl. No.: 17/628,042

(22) PCT Filed: Jul. 16, 2020
(86) PCT No.: PCT/IB2020/020037

§ 371 Date: Jan. 18, 2022

Related U.S. Application Data
(60) Provisional application No. 62/874,715, filed on Jul. 16, 2019.

(51) Int. Cl. C08F 210/02; B29C 49/00; B29C 49/12; B29C 49/06

(52) U.S. Cl. CPC C08F 210/02; B29C 49/0005; B29C 49/12; B29C 49/06; B29K 2023/06; B29K 2995/0063; B29L 2031/7158

(57) ABSTRACT

A polyethylene-based resin composition for injection stretch blow molding may include a copolymer of ethylene and one or more C4-C8 α-olefins. The composition may have a density, according to ASTM D792, that ranges from about 0.946 to 0.960 g/cm³ and a melt index (15), as measured according to ASTM D 1238 at 190° C. under a 5.0 kg load, ranging from about 5.0 to 50 g/10 min. A method of producing an article may include injection molding the composition to give a preform; and stretch-blowing the preform to provide the article.

### BACKGROUND

Hollow articles, such as containers, are often produced by injection stretch blow molding (ISBM) thermoplastic polymers. ISBM generally includes two steps: injection molding the polymer to provide a preform and subsequently stretch-blowing the preform to provide an expanded article. ISBM may be performed as either a single-stage process, where the preform production and stretch-blowing is performed by the same machine, or a two-stage process where each step is performed separately. ISBM is widely used because it allows for the efficient, high volume production of articles.

Polyethylene is a widely used packaging material due to its unique combination of physical properties and low cost. Despite this, polyethylene resins are rarely used in ISBM processes. Instead, polyethylene articles are generally produced through extrusion blow molding, a process that disadvantageously generates a regrind. Accordingly, there exists a need for polyethylene resins and ISBM processes that are suitable for the production of polyethylene containers.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to polyethylene-based resin compositions that may include a copolymer of ethylene and one or more C4-C8 α-olefins, wherein the copolymer has a density, according to ASTM D792, that ranges from about 0.946 to 0.960 g/cm³ and a melt index (I5), as measured according to ASTM D 1238 at 190° C. under a 5.0 kg load, ranging from about 5.0 to 50 g/10 min.

In another aspect, embodiments disclosed herein relate to polyethylene-based resin compositions that may include a copolymer of ethylene and one or more C4-C8 α-olefins, wherein the copolymer has a number average molecular weight (Mₙ) that ranges from about 13.0 to 19.0 kDa.

In another aspect, embodiments disclosed herein relate to articles that may include a polyethylene-based resin composition that includes a copolymer of ethylene and one or more C4-C8 α-olefins. The polyethylene-based resin compositions may include a copolymer of ethylene and one or more C4-C8 α-olefins, wherein the copolymer has a density, according to ASTM D792, that ranges from about 0.946 to 0.960 g/cm³ and a melt index (I5), as measured according to ASTM D 1238 at 190° C. under a 5.0 kg load, ranging from about 5.0 to 50 g/10 min.

In another aspect, embodiments disclosed herein relate to articles that may include a polyethylene-based resin composition that includes a copolymer of ethylene and one or more C4-C8 α-olefins. The polyethylene-based resin compositions may include a copolymer of ethylene and one or more C4-C8 α-olefins, wherein the copolymer has a number average molecular weight (Mₙ) that ranges from about 13.0 to 19.0 kDa.

In another aspect, embodiments disclosed herein relate to method of producing a polyethylene-based resin composition that includes polymerizing the ethylene with the one or more C4-C8 α-olefins. The polyethylene-based resin composition may include a copolymer of ethylene and one or more C4-C8 α-olefins, wherein the copolymer has a density, according to ASTM D792, that ranges from about 0.946 to 0.960 g/cm³ and a melt index (I5), as measured according to ASTM D 1238 at 190° C. under a 5.0 kg load, ranging from about 5.0 to 50 g/10 min.

In another aspect, embodiments disclosed herein relate to method of producing a polyethylene-based resin composition that includes polymerizing the ethylene with the one or more C4-C8 α-olefins. The polyethylene-based resin compositions may include a copolymer of ethylene and one or more C4-C8 α-olefins, wherein the copolymer has a number average molecular weight (Mₙ) that ranges from about 13.0 to 19.0 kDa.

In another aspect, embodiments disclosed herein relate to methods of producing an article by injection molding a polyethylene-based resin composition to give a preform and stretch-blowing the preform to provide the article. The polyethylene-based resin composition may include a copolymer of ethylene and one or more C4-C8 α-olefins, wherein the copolymer has a density, according to ASTM D792, that ranges from about 0.946 to 0.960 g/cm³ and a melt index (I5), as measured according to ASTM D 1238 at 190° C. under a 5.0 kg load, ranging from about 5.0 to 50 g/10 min.

In another aspect, embodiments disclosed herein relate to methods of producing an article by injection molding a polyethylene-based resin composition to give a preform and stretch-blowing the preform to provide the article. The polyethylene-based resin composition may include a copolymer of ethylene and one or more C4-C8 α-olefins, wherein the copolymer has a number average molecular weight (Mₙ) that ranges from about 13.0 to 19.0 kDa.

In a further aspect, embodiments disclosed herein relate to articles that are made by a method that includes injection molding a polyethylene-based resin composition to give a preform and stretch-blowing the preform to provide the article. The polyethylene-based resin composition may include a copolymer of ethylene and one or more C4-C8 α-olefins, wherein the copolymer has a density, according to ASTM D792, that ranges from about 0.946 to 0.960 g/cm³ and a melt index (I5), as measured according to ASTM D 1238 at 190° C. under a 5.0 kg load, ranging from about 5.0 to 50 g/10 min.

In a further aspect, embodiments disclosed herein relate to articles that are made by a method that includes injection molding a polyethylene-based resin composition to give a preform and stretch-blowing the preform to provide the article. The polyethylene-based resin composition may include a copolymer of ethylene and one or more C4-C8 α-olefins, wherein the copolymer has a number average molecular weight (Mₙ) that ranges from about 13.0 to 19.0 kDa.

Other aspects and advantages of the claimed subject matter will be apparent from the following description and the appended claims.

### DETAILED DESCRIPTION

In one aspect, embodiments disclosed herein relate to polyethylene-based resin compositions that comprise a copolymer of ethylene and one or more C4-C8 α-olefins. In some embodiments, the composition may have a density ranging from about 0.946 to 0.949 g/cm³. In particular embodiments, the composition may have a number average molecular weight ranging from about 12.0 to 19.0 kDa.

In another aspect, one or more embodiments of the present disclosure relate to processes of producing a polyethylene-based resin composition, the processes comprising polymerizing ethylene with one or more C4-C8 α-olefins.

In a further aspect, one or more embodiments of the present disclosure relate to articles that comprise a polyethylene-based resin composition, where the composition contains a copolymer of ethylene and one or more C4-C8 α-olefins.

Compositions and processes in accordance with the present disclosure may be advantageously used for injection stretch blow molding processes, enabling the efficient production of polyethylene-containing articles. Articles in accordance with the present invention may provide a reduced weight ratio as compared to conventional extrusion blow molding articles, while providing excellent mechanical properties such as impact resistance and rigidity.

Polyethylene-Based Compositions

One or more embodiments of the present disclosure are directed to resin compositions that comprise an ethylene-based copolymer. In some embodiments, the resin composition may comprise a copolymer of ethylene and one or more comonomers. The comonomers may be α-olefins. In particular embodiments, the resin composition may comprise a copolymer of ethylene and one or more C4-C8 α-olefins. The α-olefins of some embodiments may be selected from the group consisting of propene, 1-butene, 1-hexene, and 1-octene, and may preferably be 1-butene or 1-hexene and most preferably be 1-butene.

In one or more embodiments, polyethylene-based resin compositions in accordance with the present disclosure may have a total comonomer content, as measured by FTIR according to ASTM D6645, ranging from about 0.1 to 10% by weight (wt. %), relative to the total weight of the copolymer. In particular embodiments, polyethylene-based resin compositions may have a total comonomer content incorporated into the polymer ranging from a lower limit of any of 0.1, 0.5, 1.0, 2.0 or 3.0 wt. % to an upper limit of any of 3.0, 3.5, 4.90, 4.5, or 5.0 wt. %, where any lower limit may be used with any upper limit. In some embodiments, ethylene-based copolymers may have a total comonomer content incorporated in the polymer ranging from 1.0 to 5.0 wt. %.

In one or more embodiments, polyethylene-based resin compositions in accordance with the present disclosure may have a density, according to ASTM D792, ranging from about 0.940 to 0.960 g/cm³. In particular embodiments, polyethylene-based resin compositions may have a density ranging from a lower limit of any of 0.940, 0.942, 0.944, 0.946, 0.948 or 0,949 g/cm³ to an upper limit of any of 0.948, 0,949, 0.950, 0.952, 0,953, 0.954, 0.956 or 0.960 g/cm³, where any lower limit can be used with any upper limit. In some embodiments, polyethylene-based resin compositions may have a density ranging from about 0.946 to 0.953 g/cm³. In other embodiments, polyethylene-based resin compositions may have a density ranging from about 0.946 to 0.949 g/cm³.

Polyethylene-based resin compositions in accordance with the present disclosure may have a number average molecular weight (Mₙ) ranging from about 5.0 to 50 kDa. In particular embodiments, polyethylene-based resin compositions may have a Mₙ ranging from a lower limit of any of 5.0, 6.0, 8.0, 10.0, 12.5, 13.0, 15.0, or 17.0 kDa to an upper limit of any of 14.0, 14.5, 18.0, 19.0, 20.0, 22.5, 25.0, 35.0 or 50 kDa, where any lower limit can be used with any upper limit. In some embodiments, polyethylene-based resin compositions may have a Mₙ ranging from about 13.0 to 19.0 kDa or from about 13.0 to 14.5 kDa.

Polyethylene-based resin compositions in accordance with the present disclosure may have a weight average molecular weight (M_{w}) ranging from about 50 to 500 kDa. In particular embodiments, polyethylene-based resin compositions may have a M_{w} ranging from a lower limit of any of 50, 70, 80, 90, 100, 110, 120, or 125 kDa to an upper limit of any of 115, 130, 140, 150, 180, 200, 225, 250, 350, or 500 kDa, where any lower limit can be used with any upper limit. In some embodiments, polyethylene-based resin compositions may have a M_{w}, ranging from about 90 to 140 kDa or from about 100 to 115 kDa.

In one or more embodiments, polyethylene-based resin compositions in accordance with the present disclosure may have a z-average molecular weight (M_{z}) ranging from about 100 to 1000 kDa. In particular embodiments, polyethylene-based resin compositions may have a M_{z} ranging from a lower limit of any of 100, 150, 200, 250, 300, 350, 400, 450, 500, 550, or 600 kDa to an upper limit of any of 570, 650, 700, 750, 800, 900 or 1000 kDa, where any lower limit can be used with any upper limit. In some embodiments, polyethylene-based resin compositions may have a M_{z} ranging from about 500 to 750 kDa or from about 550 to 570 kDa.

In one or more embodiments, polyethylene-based resin compositions in accordance with the present disclosure may have a molecular weight distribution (M_{w}/Mₙ) ranging from about 2.0 to 50.0. In particular embodiments, polyethylene-based resin compositions may have a molecular weight distribution ranging from a lower limit of any of 2.0, 3.0, 4.0, 5.0, 6.0, or 7.0 to an upper limit of any of 8.0, 9.0, 10.0, 12.5, 15.0, 20.0, 30.0, 40.0, or 50.0, where any lower limit can be used with any upper limit. In some embodiments, polyethylene-based resin compositions may have a molecular weight distribution molecular weight distribution ranging from about 6.0 to 10.0 or from about 7.0 to 9.0.

In one or more embodiments, polyethylene-based resin compositions in accordance with the present disclosure may have a M_{z}/M_{w} ratio ranging from about 1.0 to 40.0. In particular embodiments, polyethylene-based resin compositions may have a M_{z}/M_{w} ratio ranging from a lower limit of any of 1.0, 1.5, 2.0, 3.0, 3.5, 4.0, or 5.0 to an upper limit of any of 5.0, 5.5, 6.0, 7.5, 10.0, 15.0, 20.0, 30.0, or 40.0, where any lower limit can be used with any upper limit. In some embodiments, polyethylene-based resin compositions may have a M_{z}/M_{w} ratio ranging from about 2.0 to 6.0 or from about 3.5 to 5.5.

Mw, Mn, Mz, Mw/Mn and Mz/Mw may be measured by gel permeation chromatography (GPC). The GPC experiments may be carried out by gel permeation chromatography coupled with triple detection, with an infrared detector IRS and a four-bridge capillary viscometer (PolymerChar) and an eight-angle light scattering detector (Wyatt). A set of 4 mixed bed, 13 μm columns (Tosoh) may be used at a temperature of 140° C. The experiments may use a concentration of 1 mg/mL, a flow rate of 1 mL/min, a dissolution temperature and time of 160° C. and 90 minutes, respectively, an injection volume of 200 μL, and a solvent of trichlorium benzene stabilized with 100 ppm of BHT.

Polyethylene-based resin compositions in accordance with one or more embodiments of the present disclosure may have a monomodal or a multimodal molecular weight distribution. The multimodal compositions of some embodiments may comprise at least a low molecular weight fraction and a high molecular weight fraction. In particular embodiments, the multimodal compositions may have a bimodal molecular weight distribution.

The multimodal compositions in accordance with one or more embodiments may contain the high molecular weight fraction in an amount ranging from about 20 to 80 wt. %, with respect to the total weight of the composition. In particular embodiments, the composition may contain the high molecular weight fraction in an amount ranging from about 40 to 60 wt. %.

The multimodal compositions in accordance with one or more embodiments may contain the low molecular weight fraction in an amount ranging from about 20 to 80 wt. %, with respect to the total weight of the composition. In particular embodiments, the composition may contain the low molecular weight fraction in an amount ranging from about 40 to 60 wt. %.

The low molecular weight fraction of some embodiments may have a density, according to ASTM D792, ranging from about 0.945 to 0.975 g/cm³. In particular embodiments, the low molecular weight fraction may have a density ranging from a lower limit of any of 0.945, 0.947, 0.949, 0.950, 0.952 or 0.957 g/cm³ to an upper limit of any of 0.960, 0.963, 0.966, 0.968, 0.970 or 0.975 g/cm³, where any lower limit can be used with any upper limit. In some embodiments, the low molecular weight fraction may have a density ranging from about 0.950 to 0.970 g/cm³.

Multimodal polyethylene-based resin compositions in accordance with one or more embodiments of the present disclosure may have a low molecular weight fraction having a melt index (I5), according to ASTM D1238 at 190° C. under a 5 kg load, ranging from about 20 to 70 g/10 min. In particular embodiments, the low molecular weight fraction may have a melt index (I5) ranging from a lower limit of any of 20, 30, 40, or 45 g/10 min to an upper limit of any of 50, 55, 60, or 70 g/10 min, where any lower limit can be used with any upper limit. In one or more embodiments, the low molecular weight fraction may have a melt index (I5), measured according to ASTM D1238 at 190° C. under a 5 kg load, ranging from about 45 to 50 g/10 min.

Multimodal polyethylene-based resin compositions in accordance with one or more embodiments of the present disclosure may have a low molecular weight fraction having a melt index (I21), according to ASTM D1238 at 190° C. under a 21.6 kg load, ranging from about 80 to 250 g/10 min. In particular embodiments, the low molecular weight fraction may have a melt index (I21) ranging from a lower limit of any of 80, 90, 100. 110, 116, or 120 g/10 min to an upper limit of any of 130, 150, 170, 180, 200, 230 or 250 g/10 min, where any lower limit can be used with any upper limit. In one or more embodiments, the low molecular weight fraction may have a melt index (I21), measured according to ASTM D1238 at 190° C. under a 21.6 kg load, ranging from about 116 to 130 g/10 min.

The high molecular weight fraction of the multimodal polyethylene-based resin in some embodiments may have a density, according to ASTM D792, ranging from about 0.910 to 0.960 g/cm³. In particular embodiments, the high molecular weight fraction may have a density ranging from a lower limit of any of 0.910, 0.920, 0.930, 0.935, 0.938 or 0.940 g/cm³ to an upper limit of any of 0.940, 0.945, 0.946, 0.950, 0.955 or 0.960 g/cm³, where any lower limit can be used with any upper limit. In some embodiments, the low molecular weight fraction may have a density ranging from about 0.938 to 0.946 g/cm³.

Multimodal polyethylene-based resin compositions in accordance with one or more embodiments of the present disclosure may have a high molecular weight fraction having a melt index (I21), according to ASTM D1238 at 190° C. under a 21.6 kg load, ranging from about 10 to 60 g/10 min. In particular embodiments, the high molecular weight fraction may have a melt index (I21) ranging from a lower limit of any of 10, 20, 25, 30, 35, 36, 40, or 45 g/10 min to an upper limit of any of 40, 42, 44, 50, 55 or 60 g/10 min, where any lower limit can be used with any upper limit. In one or more embodiments, the high molecular weight fraction may have a melt index (I21), measured according to ASTM D1238 at 190° C. under a 21.6 kg load, ranging from about 36 to 44 g/10 min. The multimodal compositions in accordance to the present disclosure may comprise a low molecular weight fraction that is a homopolymer of ethylene and a high molecular weight fraction that is a copolymer of ethylene. In another embodiment, the low molecular weight fraction may be a copolymer of ethylene and the high molecular weight fraction may be a homopolymer of ethylene. In particular embodiments, the low molecular weight and high molecular weight fractions may both be copolymers of ethylene. It is understood by those skilled in the art that, although homopolymers in multimodal compositions are substantially free of comonomers, some degree of comonomers may be present in the polymer chains due to their presence as impurities in ethylene streams such as in multi-stage polymerizations processes.

Polyethylene-based resin compositions in accordance with the present disclosure may optionally further comprise one or more additives that modify various physical and/or chemical properties of the composition. Such additives may be selected from, for example, flow lubricants, antistatic agents, clarifying agents, nucleating agents, beta-nucleating agents, slippage agents, antioxidants, antacids, light stabilizers, IR absorbers, silica, titanium dioxide, organic dyes, organic pigments, inorganic dyes, inorganic pigments, and combinations thereof. One of ordinary skill in the art will appreciate, with the benefit of this disclosure, that the choice of additive may be dependent upon the intended use of the composition and/or articles produced therefrom. It will also be appreciated that such additives are not limited to those described above.

Properties

Polyethylene-based resin compositions in accordance with embodiments of the present disclosure will generally possess physical properties suitable for the intended use of the composition and the articles produced therefrom. One of ordinary skill in the art, with the benefit of this present disclosure, will appreciate that altering the relative amounts and/or identities of the components of a polymer composition will influence the resulting properties of the composition.

In one or more embodiments, polyethylene-based resin compositions in accordance with the present disclosure may have a melt index (I2), as measured according to ASTM D 1238 at 190° C. under a 2.16 kg load, ranging from about 0.01 to 60 g/10 min. In particular embodiments, polyethylene-based resin compositions may have a melt index (I2), at 190° C. under a 2.16 kg load, ranging from a lower limit of any of 0.01, 0.10, 0.20, 0.50, 1.0, 1.6, 2.0, 2.5, or 5.0 g/10 min to an upper limit of any of 1.8, 2.0, 2.2, 2.4, 2.7, 3.0, 4.0, 5.0, 10, 30, or 60 g/10 min, where any lower limit can be used with any upper limit. In some embodiments, polyethylene-based resin compositions may have a melt index (I2), as measured according to ASTM D 1238 at 190° C. under a 2.16 kg load, ranging from about 1.6 to 2.4 g/10 min.

In one or more embodiments, polyethylene-based resin compositions in accordance with the present disclosure may have a melt index (I5), as measured according to ASTM D 1238 at 190° C. under a 5.0 kg load, ranging from about 5.0 to 50 g/10 min. In particular embodiments, polyethylene-based resin compositions may have a melt index (I5), at 190° C. under a 5.0 kg load, ranging from a lower limit of any of 5.0, 6.0, 10, 12, 20, or 25 g/10 min to an upper limit of any of 3.0, 5.0, 10, 16, 20, 30, or 50 g/10 min, where any lower limit can be used with any upper limit. In some embodiments, polyethylene-based resin compositions may have a melt index (I5), as measured according to ASTM D 1238 at 190° C. under a 5.0 kg load, ranging from about 12 to 16 g/10 min.

In one or more embodiments, polyethylene-based resin compositions in accordance with the present disclosure may have a high load melt index (I21), as measured according to ASTM D 1238 at 190° C. under a 21.6 kg load, ranging from about 1.0 to 120 g/10 min. In particular embodiments, polyethylene-based resin compositions may have a high load melt index (I21), at 190° C. under a 21.6 kg load, ranging from a lower limit of any of 1.0, 5.0, 10, 20, 30, 40, 50, 60, 65, 68, 70, 72, 80, or 90 g/10 min to an upper limit of any of 70, 75, 80, 90, 100, 110, or 120 g/10 min, where any lower limit can be used with any upper limit. In some embodiments, polyethylene-based resin compositions may have a high load melt index (I21), as measured according to ASTM D 1238 at 190° C. under a 21.6 kg load, ranging from about 68 to 100 g/10 min.

In one or more embodiments, polyethylene-based resin compositions in accordance with the present disclosure may have a melt index ratio (MFR), which is the ratio between the melt index (I21) measured according to ASTM D 1238 at 190° C. under a 21.6 kg load and the melt index (I2) measured according to ASTM D 1238 at 190° C. under a 2.16 kg load, ranging from about 10 to 150. In particular embodiments, polyethylene-based resin compositions may have a MFR, ranging from a lower limit of any of 10, 15, 20, 22, 30, 40, 50, 60, 80, or 90 to an upper limit of any of 40, 50, 55, 60 80, 100, 130, or 150 g/10 min, where any lower limit can be used with any upper limit. In some embodiments, polyethylene-based resin compositions may have a MFR ranging from about 22 to 55. In one or more embodiments, polyethylene-based resin compositions in accordance with the present disclosure may have a 1% secant modulus, as measured according to ASTM D 790, ranging from about 600 to 2000 MPa. In particular embodiments, polyethylene-based resin compositions may have a 1% secant modulus ranging from a lower limit of any of 600, 700, 800, 850, 900, 950, 1000 or 1050 MPa to an upper limit of any of 1100, 1200, 1300, 1500, 1750, or 2000 MPa, where any lower limit can be used with any upper limit. In some embodiments, polyethylene-based resin compositions may have a 1% secant modulus, as measured according to ASTM D 790, ranging from about 900 to 1300 MPa.

In one or more embodiments, polyethylene-based resin compositions in accordance with the present disclosure may have an Izod impact resistance at 23° C., as measured according to ASTM D 256, ranging from about 0.1 to 100 J/m. In particular embodiments, polyethylene-based resin compositions may have a Izod impact resistance at 23° C. ranging from a lower limit of any of 0.1, 1.0, 5.0, 10, 20, 30, 40, 50, 55, 60 or 70 J/m to an upper limit of any of 65, 70, 75, 80, 85, 90, or 100 J/m, where any lower limit can be used with any upper limit. In some embodiments, polyethylene-based resin compositions may have an Izod impact resistance at 23° C., as measured according to ASTM D 256, ranging from about 50 to 80 J/m.

In one or more embodiments, a pressed 2 mm specimen (prepared according to ASTM D4703) of a polyethylene-based resin composition in accordance with the present disclosure may have a yield stress, as measured according to ASTM D638, ranging from about 10 to 80 MPa. In particular embodiments, polyethylene-based resin compositions may have a yield stress ranging from a lower limit of any of 10, 13, 15, 17, 20, 22, or 25 MPa to an upper limit of any of 28, 30, 35, 40, 50, 60, 70, or 80 MPa, where any lower limit can be used with any upper limit. In some embodiments, polyethylene-based resin compositions may have a yield stress ranging from about 15 to 40 MPa.

A pressed 2 mm specimen (prepared according to ASTM D4703) of a polyethylene-based resin composition of one or more embodiments in accordance with the present disclosure may have a rupture stress, as measured according to ASTM D638, ranging from about 10 to 1000 MPa. In particular embodiments, polyethylene-based resin compositions may have a rupture stress ranging from a lower limit of any of 10, 20, 25, 30, 35, 40, or 60 MPa to an upper limit of any of 35, 39, 40, 45, 50, 75, 100, 250, 500, or 1000 MPa, where any lower limit can be used with any upper limit. In some embodiments, polyethylene-based resin compositions may have a rupture stress ranging from about 20 to 50 MPa.

In one or more embodiments, a pressed 2 mm specimen (prepared according to ASTM D4703) of a polyethylene-based resin composition in accordance with the present disclosure may have a yield strain, as measured according to ASTM D638, ranging from about 3 to 40%. In particular embodiments, polyethylene-based resin compositions may have a yield strain ranging from a lower limit of any of 3, 4, 5, 6, 8, 10, 15 or 20% to an upper limit of any of 10, 12, 15, 20, 25, 28, 30 or 40%, where any lower limit can be used with any upper limit. In some embodiments, polyethylene-based resin compositions may have a yield strain ranging from about 15 to 40%.

In one or more embodiments, a pressed 2 mm specimen (prepared according to ASTM D4703) of a polyethylene-based resin composition in accordance with the present disclosure may have a rupture strain, as measured according to ASTM D638, ranging from about 1000 to 3000%. In particular embodiments, polyethylene-based resin compositions may have a rupture strain ranging from a lower limit of any of 1000, 1250, 1500, 1750, 2000, 2100, or 2200% to an upper limit of any of 2300, 2400, 2500, 2750, or 3000%, where any lower limit can be used with any upper limit. In some embodiments, polyethylene-based resin compositions may have a rupture strain ranging from about 1500 to 2500%.

In one or more embodiments, a pressed 10 mm specimen (prepared according to ASTM D4703) of a polyethylene-based resin composition in accordance with the present disclosure may have an environmental stress cracking (full notch creep test or FNCT), measured according to ISO 16770 under a load of 4 MPa at 80° C. in monoethylene glycol, ranging from about 1 to 400 min. In some embodiments, polyethylene-based resin compositions may have an FNCT of 40 to 80 min.

Polyethylene-based resin compositions in accordance with one or more embodiments of the present disclosure may have a crystallinity, measured according to ASTM D3418, ranging from about 10 to 98%, relative to a theoretical enthalpy for 100% crystalline polyethylene of 286.18 J/g. In particular embodiments, polyethylene-based resin compositions may have a crystallinity ranging from a lower limit of any of 10, 20, 30, 40, 50, 60, or 65% to an upper limit of any of 70, 75, 80, 90, 95, or 98%, where any lower limit can be used with any upper limit.

Polyethylene-based resin compositions in accordance with one or more embodiments of the present disclosure may have a Shore D hardness, measured according to ASTM D2240, ranging from about 10 to 50 Shore D. In particular embodiments, polyethylene-based resin compositions may have a Shore D hardness ranging from a lower limit of any of 10, 15, 20, or 25 Shore D to an upper limit of any of 30, 35, 40, 45, or 50 Shore D, where any lower limit can be used with any upper limit.

In one or more embodiments, polyethylene-based resin compositions in accordance with the present disclosure may have a heat deflection temperature, measured according to ASTM D648 at 0.455 MPa, ranging from about 30 to 80° C. In particular embodiments, polyethylene-based resin compositions may have a heat deflection temperature ranging from a lower limit of any of 30, 35, 40, 45, 50, 55, or 60° C. to an upper limit of any of 65, 70, 75, or 80° C., where any lower limit can be used with any upper limit.

In one or more embodiments, polyethylene-based resin compositions in accordance with the present disclosure may have a Vicat softening temperature, measured according to ASTM D1525 at 10 N, ranging from about 100 to 150° C. In particular embodiments, polyethylene-based resin compositions may have a Vicat softening temperature ranging from a lower limit of any of 100, 110, 115, 120, or 125° C. to an upper limit of any of 130, 135, 140, or 150° C., where any lower limit can be used with any upper limit.

The composition of any of the above claims, wherein the composition has a complex viscosity, measured according to ASTM D4440, ranging from about 3000 to 6000 Pa·s at 0.09 rad/s and from about 500 to 2000 Pa·s at 100 rad/s. In particular embodiments, polyethylene-based resin compositions may have a complex viscosity at 0.09 rad/s ranging from a lower limit of any of 3000, 3500, 4000, 42500, or 4500 Pa·s to an upper limit of any of 4600, 4800, 5000, 5500, or 6000 Pa·s, and a complex viscosity at 100 rad/s ranging from a lower limit of any of 500, 750, 900, or 950 Pa·s to an upper limit of any of 1000, 1100, 1200, 1500, or 2000 Pa·s, where any lower limit can be used with any upper limit.

Methods of Preparing Compositions

Polyethylene-based resin compositions in accordance with the present disclosure may be prepared by any suitable method known in the art. In one or more embodiments, the method of preparing the polyethylene-based resin composition may be any suitable polymerization process known to one of ordinary skill in the art. In particular embodiments, the compositions may be produced by slurry-phase polymerization. In some embodiments, monomodal polyethylene-based resin compositions may be produced by a single-stage polymerization that utilizes one reactor.

In one or more embodiments, multimodal polyethylene-based resin compositions may be produced by a multistage polymerization that utilizes at least two reactors. The two or more reactors of the multistage polymerization may be connected in series. The reactors may be any suitable reactor known in the art but, in particular embodiments, may be a loop reactor or a continuous stirred-tank reactor. In some embodiments, production of a multimodal polyethylene-based reactor may include a first reactor where only ethylene is polymerized and a subsequent reactor where ethylene and a comonomer are polymerized.

In the preparation of the multimodal polyethylene-based resin compositions of some embodiments, a low molecular weight fraction may be prepared in a first reactor. In the first reactor, a comonomer may be added in an amount of about 0 to 10 kg per ton of ethene. A high molecular weight fraction may be prepared in a second reactor, wherein ethene is polymerized with a comonomer. The comonomer may be added to the second reactor in an amount of about 28 to 70 kg per ton of ethene.

Any suitable catalyst may be used in the preparation of the polyethylene-based resin compositions of the present disclosure. In one or more embodiments, polyethylene-based resin compositions may be prepared with a catalyst such as Ziegler-Natta, metallocene, or chromium catalysts. Monomodal polyethylene-based resin compositions may particularly be produced with either a Ziegler-Natta or Chromium catalyst. In some embodiments, multimodal polyethylene-based resin compositions may be prepared using a Ziegler-Natta catalyst. Examples of the Ziegler-Natta catalysts that may be utilized include, but are not limited to, one or more phthalate-based catalysts, diether-based catalysts, succinate-based catalysts, and combinations thereof. Particular embodiments of the present disclosure utilize Ziegler-Natta catalytic systems that are not phthalate-based.

In one or more embodiments, polyethylene-based resin compositions in accordance with the present disclosure may be prepared using a co-catalyst in addition to a catalyst. In one or more embodiments, the co-catalyst may be triethyl aluminum.

In one or more embodiments, polyethylene-based resin compositions in accordance with the present disclosure may be prepared using an electron donor in addition to a catalyst and a co-catalyst. In one or more embodiments, the electron donor may be selected from, but not limited to, dicyclopentyldimethoxysilane, cyclohexylmethyldimethoxysilane, diisopropyldimethoxysilane, di-t-butyldimethoxysilane, cyclohexylisopropyldimethoxy silane, n-butylmethyldimethoxysilane, tetraethoxysilane, 3,3,3 trifluoropropylmethyldimethoxysilane, mono and dialkylaminotrialkoxysilanes, and combinations thereof.

In one or more embodiments, a catalyst system may comprise a catalyst and, optionally, one or more co-catalysts and electron donors. In some embodiments, the catalyst system may be introduced at the beginning of the polymerization of ethylene, with or without one or more comonomers, and is transferred with the resulting polyethylene-based polymer to a second reactor where it serves to catalyze the copolymerization of ethylene and one or more comonomers to produce the copolymer.

As would be apparent to one of ordinary skill in the art with the benefit of the present disclosure, polyethylene-based resin compositions in accordance with the present disclosure may be prepared by any suitable method, not only those described above.

Methods of Preparing Articles from Compositions

In one or more embodiments, the polyethylene-based resin compositions in accordance with the present disclosure may be used in injection stretch blown molding (ISBM) processes, to produce polyethylene-based articles.

The ISBM process of one or more embodiments may comprise at least an injection molding step and a stretch-blowing step. In the injection molding step a polyethylene-based resin composition is injection molded to provide a preform. In the stretch-blowing step the preform is heated, stretched, and expanded through the application of pressurized gas to provide an article. The two steps may, in some embodiments, be performed on the same machine in a one-stage process. In other embodiments, the two steps may be performed separately in multiple stages.

The ISBM processes in accordance with one or more embodiments of the present disclosure may comprise an injection-molding step that involves injecting a resin composition into a cavity of a mold. The injection-molding step provides a preform, which may have an open end and a closed end. The open end may correspond to a bottleneck. Processes in accordance with one or more embodiments of the present invention may comprise extruding a polyethylene-based resin composition, plasticizing the extruded composition, and injecting the composition, under pressure, into an injection mold.

One of ordinary skill will appreciate that the injection temperature will depend upon the physical properties of the composition, to some degree. In some embodiments, this injecting may be performed at a temperature that is lower than typically found in the art. In particular embodiments, the injection of the resin composition is performed at a process temperature ranging from 170° C. to 220° C. In some embodiments, the injecting may have a process temperature ranging from a lower limit of 150, 155, 160, 165, 170, 175 or 180° C. to an upper limit of 175, 180, 185, 190, 195, 200, 210 or 220° C., where any lower limit can be used in combination with any upper limit.

The mold of one or more embodiments of the present disclosure is not particularly limited and may be any suitable mold known to one of ordinary skill in the art. In some embodiments, the mold may be a multi-cavity mold. In some embodiments, the resin composition may be injected into only one cavity of the mold, while, in other embodiments, the resin composition may be injected into more than one cavity of the mold.

The injecting process in accordance with one or more embodiments of the present disclosure may have an injection speed ranging from about 250 to 300 mm/s. In some embodiments, the injecting may have an injection speed ranging from a lower limit of 250, 255, 260, 265, 270, or 275 mm/s to an upper limit of 275, 280, 285, 290, 295 or 300 mm/s, where any lower limit can be used in combination with any upper limit.

The injecting process in accordance with one or more embodiments of the present disclosure may have an injection flow rate ranging from about 8 to 60 cm³/s in each cavity. In some embodiments, the injecting may have an injection flow rate ranging from a lower limit of 8, 20, 15, 20, 30, or 35 cm³/s to an upper limit of 30, 40, 50, or 60 cm^{3/}s, where any lower limit can be used in combination with any upper limit. The injecting process in accordance with one or more embodiments of the present disclosure may have a preform hold pressure in each cavity time ranging from about 2 to 20 s. In some embodiments, the injecting may have a preform hold pressure time ranging from a lower limit of 2, 3, 4, 5, 8 or 10 s to an upper limit of 11, 12, 13, 14, 15, 18 or 20 s, where any lower limit can be used in combination with any upper limit.

In one or more embodiments, the injecting may have an average injection pressure in each cavity ranging from about 200 to 800 bar. In some embodiments, the injecting may have an average injection pressure ranging from a lower limit of 200, 250, 300, 325, 330, 335, 340, or 345 bar, to an upper limit of 3450, 550, 600, 700, 750, or 800 bar, where any lower limit can be used in combination with any upper limit.

In one or more embodiments, the injecting may have a cooling period of the preform retained in the mold from about 4 to 25 s. In some embodiments, the injecting may have cooling period of the preform retained on the mold ranging from a lower limit of 4, 5, 6, 8, or 10 s, to an upper limit of 11, 12, 14, 15, 20 or 25 s, where any lower limit can be used in combination with any upper limit.

In one or more embodiments, the injecting may have a cooling temperature in the mold release from about 5 to 40° C. In some embodiments, the injecting may have a cooling temperature in the mold release ranging from a lower limit of 5, 10, 15, or 20° C., to an upper limit 25, 30, 35 or 40° C., where any lower limit can be used in combination with any upper limit.

In one or more embodiments, the injecting may have a total molding cycle time from about 15 to 40 s. In some embodiments, the injecting may have a total molding cycle time ranging from a lower limit of 15, 17, 20, 22 or 25 s, to an upper limit of 20, 25, 30, 35, or 40 s, where any lower limit can be used in combination with any upper limit.

In one or more embodiments, the injecting may have a total molding cycle time from about 10 to 40 s. In some embodiments, the injecting may have a total molding cycle time ranging from a lower limit of 10, 15, 17, 20, 22 or 25 s, to an upper limit of 20, 25, 30, 35, or 40 s, where any lower limit can be used in combination with any upper limit.

In one or more embodiments, the preform obtained from the injection molding process may have a wall thickness from about 1.5 to 4.0 mm. In some embodiments, the preform obtained from the injection molding process ranging from a lower limit of 1.5, 1.6, 1.7, 1.8, 1.9 or 2.0° C., to an upper limit of 2.5, 2.7, 3.0, 2.5 or 4.0 mm, where any lower limit can be used in combination with any upper limit.

In one or more embodiments, the injecting may have pressing pressure of about 300 bar. In some embodiments, the injecting may have a pressing pressure ranging from a lower limit of 280, 290, or 300 bar, to an upper limit of 300, 310, or 320 bar, where any lower limit can be used in combination with any upper limit.

In a multi-stage ISBM process in accordance with one or more embodiments of the present disclosure, the preform may be cooled to room temperature and transported to a stretch-blowing machine. In such embodiments, the preform will be reheated on the stretch-blowing machine. In a single-stage ISBM process in accordance with one or more embodiments of the present disclosure, the preform may be heated prior to stretch-blowing.

In the stretch-molding step of one or more embodiments, the preform may be positioned with the bottleneck facing downwards. The ISMB process of one or more embodiments may include stretching the preform with a stretch rod. The stretching may be performed in an axial direction. The stretching of one or more embodiments may have a stretch rod speed ranging from 500 to 1500 mm/s. In some embodiments, the stretching may have a stretch rod speed ranging from a lower limit of 500, 600, 700, 800, 900, or 1000 mm/s, to an upper limit of 800, 900, 1000, 1100, 1200 or 1500 mm/s, where any lower limit can be used in combination with any upper limit.

The temperature of the preform prior to the stretching in one or more embodiments may range from about 90 to 140° C. In some embodiments, the temperature of the preform may range from a lower limit of 90, 105, 107, 110 or 113° C., to an upper limit of 115, 117, 118, 120, 130 or 140° C., where any lower limit can be used in combination with any upper limit.

In some embodiments, the stretched preform may be radially blown by pressurized gas. The blowing is done using gas with a pressure in the range from 10 to 20 bar. In some embodiments, the pressurized gas may have a pressure ranging from a lower limit of 10, 12, 14, or 15 bar, to an upper limit of 15, 16, 18, or 20 bar, where any lower limit can be used in combination with any upper limit.

In the stretch-molding step of one or more embodiments, the preform may be blown in two or more stages. In some embodiments, the stretch-blowing comprises a first stage and a second stage, wherein the first stage uses gas of a lower pressure than the second stage. In particular embodiments, the first stage may comprise blowing gas having a pressure ranging from about 2 to 10 bar, or from about 2 to 8 bar, and the second stage may comprise blowing gas having a pressure ranging from about 10 to 20 bar.

In the stretch-molding step of one or more embodiments, the process may have an axial stretch ratio ranging from about 1.5 to 2.0, and a hoop stretch ration ranging from about 2 to 4, and a overall stretch ratio ranging from 3.0 to 10.

Processes in accordance with one or more embodiments may provide at least a yield of 500 articles/hour. In particular embodiments, methods in accordance with the present disclosure may yield 600 to 700 articles/hour on a cavity-equipped Pavan Zanetti Bimatic 4000 machine, where the articles are cylindrical bottles.

Articles

As will be apparent to one of ordinary skill in the art having the benefit of the present disclosure, articles may be formed from any of the above-mentioned polyethylene-based resin compositions or ISBM processes. The articles in accordance with some embodiments of the present invention may be hollow articles and, in particular embodiments, may be bottles. In some embodiments, the articles may be used for various food packaging applications, such as milk bottles. In other embodiments, the articles may be used for packaging cleaning products such as for detergent bottles.

Articles in accordance with one or more embodiments of the present invention may have a volume ranging from 500 to 3000 cm³, more specifically between 900 and 1200 cm³. In some embodiments, the articles may have a weight ranging from about 18 to 40 grams per article or from about 24 to 32 grams per article.

### Examples

The following examples are merely illustrative, and should not be interpreted as limiting the scope of the present disclosure.

A bimodal polyethylene with the properties described in Table 1 below was used in the injections stretch blow molding and in a conventional extrusion blow molding process.

TABLE 1
Polyethylene properties

| Catalyst | | Ziegler-Natta catalyst | |
|---|---|---|---|
| Polymerization Process | | Slurry | |
| Polyethylene | Density | 0.949 | g/cm³ |
| properties | I2 | 2.0 | g/10 min |
| | I5 | 14.1 | g/10 min |
| | I21 | 78.9 | g/10 min |
| | Mw | 120 | kDa |
| | Mn | 15 | kDa |
| | Mz | 568 | kDa |
| | Mw/Mn | 8 | |
| | Flexural | 1290 | MPa |
| | Modulus | | |
| | Yield | 27 | MPa |
| | Strength | | |
| | Tensile | 36 | MPa |
| | Strength | | |

One-liter volume bottles were prepared in a two stages ISBM process using the polyethylene above described. Preforms for the ISBM process were molded in an Arburg Allrounder 520S 1600-400/170 injector. The basic injection parameters for the preforms are shown in Table 2.

TABLE 2
Preform injection molding parameters

| Mold Closing and Opening | | Injection and Packing | |
|---|---|---|---|
| Opening Course (mm) | 180 | Real Injection Pressure (bar) | 610 |
| Closing force (kN) | 300 | Injection Velocity (cm³/s) | 14 |
| Opening Time(s) | 0.70 | Holding Pressure (bar) | 490 |
| Closing Time (s) | 2.50 | Injection Time (s) | 1.47 |
| | | Holding Time (s) | 10 |
| Dosing | | Times | |
| Screw Velocity (mm/s) | 180 | Pre-extrusion Time (s) | — |
| Dosing Course (cm³) | 27 | Cooling Time (s) | 20 |
| Backpressure (bar) | 200 | Cycle Time (s) | 37.7 |
| Decompression Course | 5 | Commutation Volume (cm³) | 11.5 |
| (cm³) | | | |

The preforms were then blown in a Pavan Zanetti 3C/2 L PETMATIC 4000 stretching blowing machine in the conditions shown in Table 3:

TABLE 3
SBM process parameters

| | |
|---|---|
| Preblow pressure (bar) | 4 |
| Oven temperature (° C.) | 153-156 |
| Stretching rod velocity (mm/s) | 1000 |
| Blow Pressure (bar) | 15 |
| Barrel temperature (° C.) | 190-210 |
| Mold Temperature (° C.) | 20 |
| Injection Velocity (cm³/s) | 14 |

The 1 L bottle produced were assayed for their weight and top load and compared to a conventional 1 L extrusion blow molded polyethylene bottle using the same polyethylene.

As a practical knowledge, the bottle's weight may be linearly correlated to the top load that the bottle supports. Due to several limitations with the conventional EBM process, such as mechanical limitation, material characteristics, and others, it is generally not possible to reduce the weight of the bottles produced in a EBM process to a final application, leading to an over dimensioned package. Using the ISMB process, it is possible to not only use a more suitable material to an application requirement but also maintain the structural behavior relationship of the bottle (top load/weight), including in a much lighter bottle, which is not possible by EBM process.

The top load compression resistance of the bottles was carried out in an Instron universal mechanical testing machine, with a 5 kN load cell and 50 mm/min crosshead speed, like described in ASTM D2659-16. The bottles were sealed with PET/cardboard/aluminum seals, from Emproplas company. The results are shown in Table 4.

| | Bottle | | Ratio (top |
|---|---|---|---|
| | weight(g) | Top load (N) | load/weight) |
| EBM | 40 | 224.85 | 5.62 |
| ISBM | 30.5 | 198.06 | 6.49 |

It is possible to observe that the correlation of top load to weight can be at least maintained (or even have a better top load to weight ratio) with the bottle produced with the ISBM process using the polyethylene and the process parameters as described in the present disclosure when compared to a EBM bottle, with a reduction of around 25% of the bottle weight.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

1. A polyethylene-based resin composition for injection stretch blow molding, the composition comprising a copolymer of ethylene and one or more C4-C8 α-olefins,
wherein the composition has:
(i) a density, according to ASTM D792, ranging from about 0.946 to 0.960 g/cm³ and a melt index (I5), as measured according to ASTM D 1238 at 190° C. under a 5.0 kg load, ranging from about 5.0 to 50 g/10 min
and/or
(ii) a number average molecular weight (Mₙ) ranging from about 13.0 to 19.0 kDa.

2. (canceled)

3. (canceled)

4. (canceled)

5. The composition of claim 1, wherein the composition has a density, according to ASTM D792, ranging from about 0.946 to 0.949 g/cm³.

6. The composition of claim 1, wherein the composition has a number average molecular weight (Mₙ) ranging from about 13.0 to 14.5 kDa.

7. The composition of claim 1, wherein the composition has a weight average molecular weight (M_{w}) ranging from about 50 to 500 kDa, a z-average molecular weight (M_{z}) ranging from about 100 to 1000 kDa, and/or a molecular weight distribution (M_{w}/Mₙ) ranging from about 2 to 50.

8. (canceled)

9. (canceled)

10. The composition of claim 1, wherein at least one of the one or more α-olefins is selected from the group consisting of propene, 1-butene, 1-hexene, and 1-octene.

11. The composition of claim 10, wherein the at least one of the one or more α-olefins is 1-butene.

12. (canceled)

13. The composition of claim 1, wherein the composition has a melt index (I2), as measured according to ASTM D 1238 at 190° C. under a 2.16 kg load, ranging from about 0.01 to 60 g/10 min, and/or a high load melt index (I21), as measured according to ASTM D 1238 at 190° C. under a 21.6 kg load, ranging from about 10 to 120 g/10 min.

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. The composition of claim 1, wherein the composition is multimodal and comprises a low molecular weight fraction and a high molecular weight fraction, wherein the low molecular weight fraction has a density, according to ASTM D792, ranging from about 0.945 to 0.975 g/cm³ and/or a melt index (I5), according to ASTM D1238 at 190° C. under a 5 kg load, ranging from about 20 to 70 g/10 min.

29. (canceled)

30. (canceled)

31. (canceled)

32. (canceled)

33. A process of producing the composition of claim 1, the process comprising polymerizing the ethylene with the one or more C4-C8 α-olefins, and wherein the polymerization comprises the use of a Ziegler-Natta catalyst or a chromium catalyst.

34. (canceled)

35. The process of claim 33, wherein the polymerization is a slurry-phase polymerization

36. (canceled)

37. The process of claim 33, wherein the polymerization is performed in two or more reactors.

38. (canceled)

39. (canceled)

40. (canceled)

41. A method of producing an article, the method comprising: injection molding the composition of claim 1 to give a preform; and stretch-blowing the preform to provide the article,

42. (canceled)

43. The method of claim 41, wherein the injection of the resin composition is performed at a process temperature ranging from 170° C. to 220° C.

44. (canceled)

45. (canceled)

46. The method of any of claim 41, wherein the injecting has an injection flow rate in each cavity ranging from about 8 to 60 cm³/s.

47. The method of claim 41, wherein the injecting has an injection pressure in each cavity ranging from about 200 to 800 bar.

48. (canceled)

49. The method of claim 41, wherein the stretch-blowing comprises stretching the preform with a stretch rod having a speed ranging from 500 to 1500 mm/s during the stretching of the preform.

50. (canceled)

51. (canceled)

52. The method of claim 41, wherein the stretch-blowing comprises blowing the preform with gas having a pressure ranging from about 10 to 20 bar during the blowing.

53. (canceled)

54. The method of claim 52, wherein the stretch-blowing comprises blowing the preform with gas in at least a first stage and a second stage, wherein the first stage uses gas of a lower pressure than the second stage.

55. (canceled)

56. The method of claim 54, wherein a first stage comprises blowing gas having a pressure ranging from about 4 to 10 bar and a second stage comprises blowing gas having a pressure ranging from about 10 to 20 bar.

57. An article produced by the method of claim 41, wherein the article is a bottle.

58. (canceled)

59. (canceled)

60. (canceled)
